(19) United States
(12) Patent Application Publication
(10) Pub. No.: US 2006/0200570 A1
(43) Pub. Date: Sep. 7, 2006

(54) Discovering and mounting network file systems via ad hoc, peer-to-peer networks

(75) Inventors: Vlad Stirbu, Tampere (FI); Mika Saaranen, Pirkkala (FI)

Correspondence Address: Hollingsworth & Funk, LLC;Suite 125, 8009 34th Avenue South, Minneapolis, MN, 55425, US

(73) Assignee: Nokia Corporation

(21) Appl. No.: 11/070,375

(22) Filed: Mar. 2, 2005

(51) Int. Cl. G06F 15/16

(52) U.S. Cl. 709/230

(57) ABSTRACT

Network file systems are mounted to a client arrangement via a local, ad hoc, peer-to-peer network. The client arrangement is coupled to the network, and one or more network file protocols that are compatible with the client arrangement are determined. Using XML-based discovery protocols of the network, descriptors of the one or more network file protocols are sent to a file server coupled to the network. A descriptor of at least one network file protocol compatible with the file server are received from the file server. The compatible file protocol is selected from the one or more network protocols. A network file system provided by the file server is mounted to the client arrangement using the compatible network file protocol.

### FIELD OF THE INVENTION

This invention relates in general to network data processing, and more particularly to mounting network file systems in an ad-hoc, peer-to-peer local area network.

### BACKGROUND OF THE INVENTION

Mobile communications devices such as cell phones are gaining wider acceptance. The popularity of these devices is due in part to the capabilities being added to such devices. Modem mobile technologies have become an important niche in the growing field of personal digital communications. Modem cell phones and related devices offer an ever-growing list of digital capabilities. For example, many phones are equipped with cameras and color displays that allow the phones to act as a both digital camera and image viewer.

With the increasing numbers of mobile multimedia capable devices, the problem of where to store all of that multimedia data becomes more important. Still images and videos captured using a built-in mobile camera can fill up a mobile phone's local storage rather quickly. The phone users either have to delete images to make more space, or offload the images to another device, such as a computer hard drive.

Portable devices may also be used to capture text data input by the user. This text data may be for communications purposes (e.g., text messaging) or may be for purposes of memorializing a user's thoughts (e.g., journal). In either case, the user may want to keep certain versions of the text data local, but offload portions of the text to external storage, thereby saving space on the portable device.

For some time, general-purpose computers have had the ability to easily transfer data between devices. Home computers often use compatible hardware running compatible operating systems. Therefore, data transfer between home computers is-usually simple if both machines have compatible removable data storage devices, or if both machines are coupled to a properly configured home network. Even when machines run different OSes, various hardware and software adaptations can provide nearly effortless inter-device data transfer. These adaptations include the ability to read non-native file systems, network file systems, and the use of Web-based data transfer and data storage mechanisms.

However, it can be more difficult to perform such data transfers from a small, specialized device like a cellular phone. Portable devices cannot always share data with other computing systems so effortlessly. These devices often run specialized hardware and operating systems, and thus may require special software to be used. This specialized software is usually installed on the home computer or similar device, although sometimes the portable device itself might also need software additions or upgrades in order to share data. If the home computer does not run an operating system compatible with this specialized software, then sharing between the computer and mobile device may not be possible at all.

Another problem with transferring data from portable devices has to do with limited user interfaces. Compared to a cell phone, a home computer has an enormous display and easily manipulated input devices (e.g., keyboard and mouse). While inter-device transfers on home computers can be as simple as drag-and-drop across a virtual desktop, transfers from a cellular device may involve a substantial amount of scrolling and button pushing just to find the file, and similarly tedious manipulations to effectively transfer the file. Of course, the transfers may be initiated at the receiving device (e.g., the computer), but in many cases, such as a home media server, direct user interface access to the computer is not always convenient. Also, where data transfers occur away from the home (e.g., via the Internet), the user has no access to the receiving device, and must rely on the portable device alone to effectuate data transfers.

Although offloading files such as photos from a portable device may be performed infrequently for some users, other emerging uses for portable devices may require more frequent synchronization of data. In particular, Web logging (also referred to as “blogging”) involves creating a running commentary on a user's personal Web page. The maintainer of the site, i.e., the “blogger”, needs to continually access the site to add new content. For certain users and situations (e.g., a person who is on travel), a portable device may be the best (or only) way to create new content for the blog.

One problem in particular in transferring data between portable devices and home-based remote content storage devices relates to automatically mounting and configuring the storage devices on the portable device. Manually mounting and configuring a remote file system is cumbersome and difficult for the average user. Current methods for auto-configuration are generally useful only for systems that are specific to cellular communications, so easier method for accessing and configuring remote digital storage for the home networks is required.

### SUMMARY OF THE INVENTION

The present disclosure relates to mounting network file systems in an ad-hoc, peer-to-peer local area network. In accordance with one embodiment of the invention, a method involves mounting network file systems to a client arrangement via a local, ad hoc, peer-to-peer network. The client arrangement is coupled to the network, and one or more network file protocols that are compatible with the client arrangement are determined. Using XML-based discovery protocols of the network, descriptors of the one or more network file protocols are sent to a file server coupled to the network. A descriptor of at least one network file protocol compatible with the file server are received from the file server. The compatible file protocol is selected from the one or more network protocols. A network file system provided by the file server is mounted to the client arrangement using the compatible network file protocol.

In more particular embodiments, the method further involves receiving a signal to disconnect the client arrangement from the ad-hoc peer to peer, local area network, and unmounting the network file system using the compatible network file protocol in response to the signal. The method may also further involve, after mounting the network file system, synchronizing the content of data files that have a first version located on the client arrangement and a second version located on the file server, wherein the first version differs from the second version.

In one arrangement, determining the one or more network file protocols comprises querying the client arrangement using the XML-based discovery protocols to determine the one or more network file protocols that are compatible with the client arrangement. Mounting the network file system to the client arrangement using the compatible network file protocol may involve mounting the network file system using any combination of file transfer protocol (FTP), WebDAV, and server message block (SMB).

In another configuration, the ad-hoc, peer-to-peer network may include a Universal Plug and Play (UPnP) network, and sending the descriptors of the network file protocols using XML-based discovery protocols of the network may involve sending a UPnP device profile. Additionally, receiving from the file server a descriptor of at least one network file protocol compatible with the file server may involve receiving a UPnP UIListing from the file server. In yet another arrangement, determining the one or more network file protocols involves querying the client arrangement via a UPnP remote UI control point to determine the one or more network file protocols that are compatible with the client arrangement. In one configuration, mounting the file system to the client arrangement may involve connecting to the system via a UPnP remote UI client associated with the client arrangement. The mobile device may be wirelessly coupled to the network.

In another embodiment of the present invention, a data-processing arrangement includes a network interface capable of being coupled to an ad hoc, peer-to-peer, local area network. A processor is coupled to the network interface, and a memory is coupled to the processor. The memory has instructions that cause the processor to determine one or more network file protocols that are compatible with the data processing arrangement. Using XML-based discovery protocols of the network, descriptors of the one or more network file protocols are sent to a file server coupled to the network. A descriptor of at least one network file protocol compatible with the file server is received from the file server. The compatible file protocol is selected from the one or more network protocols. A network file system provided by the file server is mounted using the compatible network file protocol.

In another embodiment of the present invention, a processor-readable medium has instructions stored thereon which are executable by a data processing arrangement capable of being coupled to an ad-hoc, peer-to-peer, local area network. The instructions are executable by the data processing arrangement for performing steps that include determining one or more network file protocols that are compatible with the data processing arrangement, and sending, using XML-based discovery protocols of the network, descriptors of the one or more network file protocols to a file server coupled to the network. A descriptor of at least one network file protocol compatible with the file server is received from the file server. The compatible file protocol is selected from the one or more network protocols. A network file system provided by the file server is mounted using the compatible network file protocol.

In another embodiment of the present invention, a data-processing arrangement includes a network interface capable of being coupled to an ad hoc, peer-to-peer, local area network. The data processing arrangement also includes a data store having a local file system, and a processor is coupled to the network interface, and a memory is coupled to the processor. A memory is coupled to the processor and the data store. The memory has instructions that cause the processor to receive, using XML-based discovery protocols of the network, descriptors of one or more network file protocols that are compatible with a client arrangement coupled to the network. At least one network file protocol that is compatible with the data processing arrangement is selected from the one or more network file protocols. A descriptor of the at least one network file protocol is sent to the client arrangement, and mounting of a portion of the local file system by the client arrangement is enabled using the compatible network file protocol.

In another embodiment of the present invention, a processor-readable medium has instructions stored thereon which are executable by a data processing arrangement capable of being coupled to an ad-hoc, peer-to-peer, local area network. The instructions are executable by the data processing arrangement for performing steps that include receiving, using XML-based discovery protocols of the network, descriptors of one or more network file protocols that are compatible with a client arrangement coupled to the network. At least one network file protocol that is compatible with the data processing arrangement is selected from the one or more network file protocols. A descriptor of the at least one network file protocol is sent to the client arrangement. Mounting of a portion of a local file system of the data processing arrangement by the client arrangement is enabled using the compatible network file protocol.

In another embodiment of the present invention, a system includes: a local, ad hoc, peer-to-peer network; means for coupling a client arrangement to the network; means for determining one or more network file protocols that are compatible with the client arrangement; means for sending, using XML-based discovery protocols of the network, descriptors of the one or more network file protocols to a file server coupled to the network; means for receiving from the file server a descriptor of at least one network file protocol compatible with the file server, the compatible file protocol selected from the one or more network protocols; and means for mounting a network file system provided by the file server to the client arrangement using the compatible network file protocol.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates a network file management system in an ad-hoc, peer-to-peer network according to embodiments of the present invention;

FIG. 2 illustrates various UPnP physical and logical entities involved in discovering and mounting network file systems according to embodiments of the present invention;

FIG. 3 illustrates UPnP device descriptors used in discovering and mounting network file systems according to embodiments of the present invention;

FIG. 4 illustrates a procedure for discovering and mounting a network file system according to embodiments of the present invention;

FIG. 5 illustrates a mobile terminal that may be used for discovering, mounting, and serving a network file system according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to a system for automatically mounting network file systems via an ad-hoc, peer-to-peer networking system. Devices that can use this system include mobile devices capable of communicating via wireless networks, such as cellular phones, personal digital assistants (PDAs), and the like. The system provides these mobile devices a simple and reliable way to offload content stored on the device in order to free up space on the device. The content on the device may also be synchronized with copies that are mirrored on a network data store.

One solution off-loading data from portable devices uses mechanisms similar to those of the Unix and Windows computing platforms in order to mount remote file systems. One of these approaches utilizes a technology known as WebDAV. WebDAV, which stands for “Web-based Distributed Authoring and Versioning”, is a set of HTTP extensions that allows users to collaboratively edit and manage files on remote web servers. WebDAV provides features such as file locking, overwrite protection, name space management, version management, collection management, access control, and the like. These features deal with contention for file access and ensure data integrity for documents that are being concurrently or consecutively edited by more than one entity.

Besides these collaboration features, WebDAV provides ways to add XML format metadata to file system elements (e.g., files, folders, collections). WebDAV also allows linking other resources to file system elements using HTTP URL formats. WebDAV is widely supported in Web server software such as Apache. Web browsers generally support WebDAV through HTTP. Operating systems such as Microsoft Windows, Linux, and the Symbian OS may support mounting WebDAV file systems, such as by the use of add-on drivers.

The use of WEDAV on portable devices allows users to upload files to a network file server in order to free up local storage space. Although this solves the problem of freeing up storage space on the portable device, there is no automatic way to provide the configurations and to mount the remote file system. It will be appreciated that the integration of multimedia features into portable devices means that media content management will be a key area of concern. Portable device users will create various types of digital content, such as JPEG images from camera phones, video from camera phones, and other multimedia content. For example, content management is useful when synchronizing MP3 and other digitally formatted music between a phone and home-based digital storage

There are many ways to transfer data between machines coupled via networks. One particularly useful model of transferring data involves the use of network file systems. Generally, a file system is a way of organizing and storing data for access by a computer. File systems typically use storage media directly coupled to an input-output bus of the computer. Such directly attached media may include hard disks, compact disc-read-only memory (CD ROM), tape, diskettes, static random-access-memory, and similar tangible media.

A network file system is a virtual file system, in that the file data is not located a device directly attached to the computer. The network file system uses network file access methods that makes it appear as if remote files are on a local device. The advantage of using a virtual file system is that applications that are written to access a traditional file system (e.g., hard drive) can automatically access network data using the same library function calls, graphical controls, etc., that are used to access local files.

Many network file systems have been developed. These files systems may be built upon protocols such as the Network File System (NFS), Server Message Block (SMB), Common Internet File System (CIFS), Andrew File System (AFS), Apple Filing Protocol (AFP), Network Data Management Protocol (NDMP), Lustre, File Transfer Protocol (FTP), Hypertext Transfer Protocol (HTTP), and WebDAV. Generally, these protocols provide procedures for remotely saving, retrieving modifying, deleting, and creating files across network connections.

Although the present invention is applicable to any type of network file system protocols, a more detailed description of some of the more popular protocols are described herein below. The HTTP and FTP protocols are among the most commonly used networking protocols for transferring files. This popularity is mainly due to the growth of the Internet, and particular the World Wide Web, which is based on HTTP. HTTP a text based protocol that may be utilized over a TCP/IP link. Generally, HTTP involves clients accessing documents (usually hypertext documents) from an HTTP server using the document's Uniform Resource Locator (URL). FTP is also a text-based protocol that can be used to exchange files via networks using interactive command-line arguments. Most HTTP and FTP accesses are accomplished programmatically (e.g., via a Web browser), although users may still use text-based terminals to perform FTP and HTTP transactions.

Most computers running Windows™ can access network file systems using SMB and CIFS. SMB is a client server, request-response protocol initially developed by IBM™. SMB can be used for sharing files, printers, serial ports, and communications abstractions such as named pipes and mail slots between computers. CIFS is a variation of SMB that was developed and used by Microsoft™. Other operating systems, such as Linux™, can also access SMB and CIFS file systems using specialized software such as Samba and CIFS VFS. CIFS runs at a higher level than SMB and uses the Internet's TCP/IP protocol. CIFS can be extended for use over the Internet, and is viewed as a complement to the Internet application protocols such as FTP and HTTP.

Apple™ Macintosh™ computers running OS X natively support AFP for network file access, and may also use Samba and similar software for accessing SMB-based file systems. AFP can also be implemented on non-Apple computers. NDMP is an open protocol used to control data backup and recovery communications between primary and secondary storage in a heterogeneous network environment. NDMP defines an architecture for the backup of network file servers and enables a centralized program can to back up data on file servers running on different platforms.

Generally, files accessed via a network must be stored on physical media somewhere. The physical location of network files is usually a hard drive located on a network server. This server stores the files using native file systems (e.g., NTFS, ext3, ufs, etc.). The files are accessed over the network by a client machine, which typically creates a placeholder in the client's native file directory structure for the remote files.

For example, computers running the Windows™ operating system can map a network file system to a drive letter (e.g., “H:”). In this way, Windows applications need not know whether the file is locally or remotely located. In Unix-like systems, a remote file system can be attached anywhere in the directory structure through use of the “mount” command. For example, the command mount -t nfs server1:/var/src/usr/local/src will mount the /var/src directory of the host “server1” on to the local machine's /usr/local/src directory. Any user or program that accesses the /usr/local/src directory can perform file-management operations on the remote files and directories in exactly the same way as if they were local files and directories.

Although network file systems are very useful, most of these systems were designed in the era of desktop computing. One assumption behind the use of many of these file systems is that the client computer maintains a constant, predictable connection to the server. It is also assumed the server is located in a predictable location on the network. Usually, these network file system connections are initiated at boot-up, and the connections are intended to remain up until the user intervenes, or the computer shuts down. This assumption works fine for a non-portable environment, such as on a desktop computer. However, for portable devices, a continuous network connection will not always exist. Even if a connection does exist for a portable device, expected network resources, such as a particular server, may not be available. This is because portable devices may be called upon to enter available networks wherever the user is located, and resources that are available in a home or workplace network are not likely available elsewhere.

The typical approach used by portable devices, such as laptop computers, is to have users manually find and connect to network file systems. The user usually must locate the server, either through a saved link or by manually inputting the data. If the server responds, the user may have to perform authentication, such as entering a password. If the connection to the file system is severed while in use, the user may have to manually reconnect in this same way. Other complications may occur due to transient connections. For example, applications that were had remote files open when the link was severed may fail completely unless the applications are specially designed to account for transient file system connections.

Manually connecting to network file systems is more difficult with small, mobile devices such as cell phones and PDAs. Such devices have limited user interfaces, and it can be tedious to repeatedly go through the motions of connecting. Similarly, even the process of transferring, backing-up, and/or synchronizing files between a local and remote data store may be overly complicated for many users. Therefore, an ideal network file system for mobile devices would automatically mount remote file systems with little or no user intervention. Also, data transfer and synchronization between the local and remote file system should also occur with the least amount of user intervention necessary.

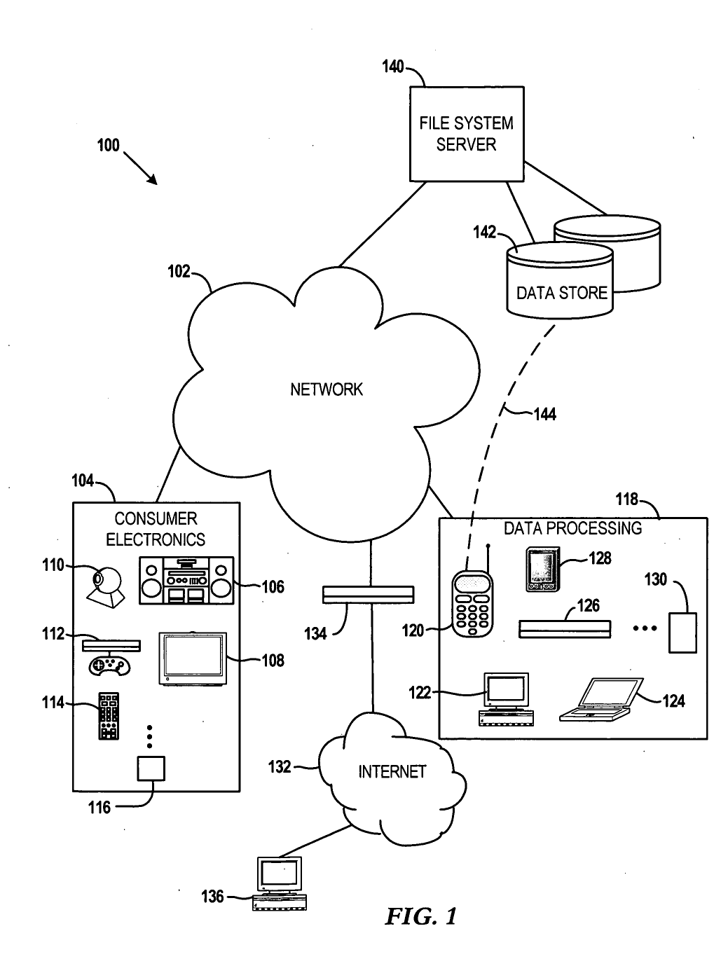

In reference now to FIG. 1, an example computing environment 100 is illustrated that includes a network file system suitable for mobile devices in accordance with embodiments of the present invention. The computing environment 100 includes a local ad-hoc network 102 suitable for facilitating peer-to-peer data exchanges between consumer electronic devices. The local network 102 may include any proximity or ad-hoc network that is adapted for consumer use.

In order to facilitate an understanding of the invention, the network 102 may described in the context of a Universal Plug and Play (UPnP) networking environment. The UPnP standard provides a way for disparate processing devices to exchange data over local networks using ad hoc, peer-to-peer network connectivity. UPnP networks leverage existing Web technologies such as IP, TCP, UDP, HTTP, and XML to enable proximity networking. Proximity networking allows for transfer of control data and content among locally situated networked devices.

The UPnP Device Architecture (UDA) is designed to support zero-configuration, “invisible” networking, and automatic discovery for a breadth of device categories from a wide range of vendors. Although the network 102 may be described in terms of UPnP networks, it will be appreciated, that the invention may be applicable in any system or application where ad-hoc, peer-to-peer data communications between consumer electronics is desired. For example, the present invention may also be applicable to other technologies such as X-10, xAP, Jini, Rendezvous, HomeRF, Bluetooth, IrDA, etc.

The UPnP network 102 is suitable for use by a wide range of electronic devices. For example, consumer electronic devices 104 may utilize the UPnP network 102. Consumer electronic devices 104 may include audio equipment 106, televisions 108, cameras 110, video games 112, infrared (IR) remote controls 114, or any other device traditionally associated with consumer entertainment, as represented by generic consumer electronic device 116.

The UPnP network 102 is also suitable for use with data processing devices 118. Data processing devices 118 generally provide computing or communications functions. Examples of data processing devices 118 include cellular phones 120, desktop computers 122, portable computers 124, routers 126, PDAs 128, or any other device as represented by generic device 130. It will be appreciated that the distinction between consumer electronic devices 104 and data processing devices 118 is somewhat arbitrary; most modem electronics include data processing functionality (e.g., embedded microprocessors) and most utility computing/communications devices have home-use applications.

The computing environment 100 is generally utilized within an area such as a home or office. Device may be coupled to the network 102 utilizing any combination of wired and wireless network interfaces and protocols. These interfaces/protocols may include 802.11 Wireless Local Area Networking (WLAN), Bluetooth™, Ethernet, USB, IEEE1394 (Firewire™), X10, or any other data transfer technology now known or later developed. The network 102 and devices 104, 118 of the UPnP network 102 may also be made externally accessible via public data transmission mediums such as the Internet 132. For example, a UPnP gateway/router 134 may allow some or all of the elements of the UPnP network 102 to access a remote device 136 via the Internet 132 or other publicly accessible medium (e.g., public airwaves).

The computing environment 100 may include special-purpose servers that may be used by any element of the UPnP network 102. For example, a network file system server 140 may provide access to one or more digital data stores 142. The file system server 140 may be implemented in a standalone device such as network attached storage (NAS), or may be implemented using a general purpose computer such as the desktop computer 122. Generally, the file system server 140 allows network-coupled devices 104, 118 to access the data store(s) 142 using any network file system protocol known in the art.

When devices 104, 118 access the file system server 140, the file structures may be presented to software of the device as if on a local file system. For example, the cellular phone 120 may include a file browser that incorporates some or all files available on the server 140 into the phone's local file system hierarchy. This virtualization of the remote files on the local device 102 is represented by path 144.

By using various features of the UPnP network 102, the client device 120 can be configured to automatically mount the desired file system without user intervention. When the client device 120 joins with the UPnP network 102, the device 120 is enabled to find, authenticate, and mount files available via the file system server 140. Also, the client 120 and server 140 may also be arranged to automatically backup or synchronize files between the entities 120, 140.

The terms “client” and “server” are used to describe particular interactions between devices (e.g., the cell phone 120) that mount network file systems and file system servers 140 that provides network access to the mounted files. However, the UPnP network 102 (and similar networks) generally facilitate peer-to-peer transactions. Therefore, the functions of client and server can be performed by any device on the network 102. Whether a device is client or server depends more on a particular transaction rather than any fixed role within the network. Devices may serve other roles besides client or server on the UPnP network 102, such as acting as intermediaries in network data exchanges.

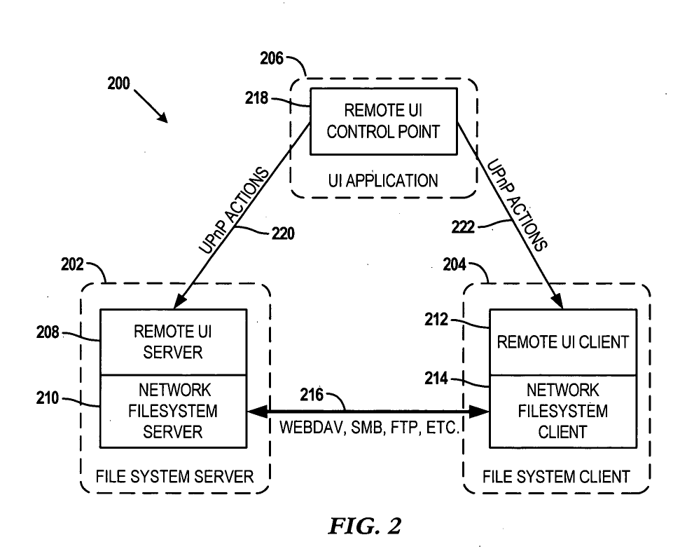

In reference now to FIG. 2, a diagram 200 illustrates example UPnP entities for providing automatic mounting of network file systems according to embodiments of the present invention. In particular, the diagram shows entities conforming to the UPnP remote user interface (UI) specification. The UPnP remote UI is designed to facilitate use of a wide variety of user interface devices to control UPnP devices. These user interface devices may be configured to coordinate closely with user activities, moving beyond the simple keyboard and mouse interface. Remote UI enables the separation of application logic from user interface. This separation of application logic from the user interface also allows any general-purpose devices to control applications via the network. This allows users to interact with an application from user interface points located throughout the local environment.

In the diagram of FIG. 2, three functional components are illustrated: a file system server 202, a file system client 204, and a UI application 206. The file system server 202 provides network clients access to files that are (usually) stored locally on the server 202. The file system client 204 accesses these files from the server 202, and typically makes the remote files appear as if on a local device for the benefit of locally running applications. The UI application 206 is involved in discovering network resources such as the file system server 202 and the file system client 204. The UI application 206can control mounting and unmounting of file systems between the server 202 and client 204. The UI application. 206 may also be enabled to control other file system management tasks, such as copying and synchronizing files between the server 202 and client 204. The UI application 206 may perform these tasks automatically and/or manually via user input on a man-machine interface.

The components 202, 204, 206 may each reside on a separate physical device. Alternatively, some components 202, 204, 206 may be combined on the same physical device. Typically, at least the file system server 202 and file system client 204 are network-coupled, thus would reside on separate physical devices. The UI application 206 may reside on the same device as the file system client 204, although it will be appreciated that the UI application 206 may also reside on the server 202 or on a third device.

Although the three functional components 202, 204, and 206 may represent different combinations of physical devices, each component generally represents a different logical UPnP device. In the UPnP framework, network entities are abstracted into logical entities known as “devices” and services. A “device” is a container for both other logical devices and for services. To differentiate between the UPnP meaning of a device and physical device, UPnP devices will be referred to herein as “logical devices.” For example, a UPnP television monitor is a physical device that may advertise itself on a UPnP network as a logical device. The logical television device may contain both a video renderer logical device and a sound renderer logical device. Each of these logical devices may have one or more associated services. The video renderer device, for example, may provide rendering services for both still and moving images.

The functional components 202, 204, and 206 shown in FIG. 2 each include a specific UPnP logical device. The file system server 202 contains a remote UI server device 208. The remote UI server device 208 runs server applications and contains a RemoteUIServer UPnP service that generally allows for discovery of user interfaces that may be operated remotely to control those applications. The remote UI server device 208 may also include a DeviceSecurity service, which provides secure access to the remote UI server device 208.

The file system server 202 also contains a network file system server module 210, which facilitates non-UPnP (or “out-of-band”) network file system accesses. The file system server module 210 provides file access using network file transfer protocols such as SMB, FTP, WebDAV, etc. The remote UI server 208 interfaces with the network file system server module 210, so that the file system management functions can be managed via UPnP. Management functions involving the network file system server module 210 may include determining connection status, enumeration of file system metadata, controlling file transfers, etc. Other out-of-band protocol functions, such as data/state synchronization, access control, encryption of data, etc., may be affected indirectly or not at all by the network file system server module 210.

The file system client 204 also includes a UPnP logical device, namely the remote UI client 212. The remote UI client 212 can be configured as a fully autonomous device that runs its own user interface. Additionally, the remote UI client 212 may provide services that allow executing UI functions remotely, or controlling a remotely accessible device having no local UI capability. The remote UI client 212 is enabled to allow a user interface device on the network to discover and control the UI client 212. These user interface devices that control the remote UI client 212 many have widely different form factors, modes of use, and behaviors. Therefore, the behavior of the remote UI client device 212 may change depending on the device used to access and control it.

In the illustrated arrangement, the remote UI client 212 is able to manage UPnP file transactions for connecting with the remote UI server 208 of the file system server 202. The remote UI client 212 interfaces with a network file system client module 214. The network file system client module 214 is able to communicate with the network file system server module 210 using mutually compatible network file system protocols, as indicated by path 216. The remote UI client 212 is able to control the network file system client 214 for purposes of managing file system interactions with the file system server 202.

The third functional component shown in FIG. 2, the UI application 206, also has its own UPnP logical device, the remote UI control point 218. The UI control point 218 provides a user with the ability to control operations that occur between UPnP network entities. In particular, the remote UI control point 218 provides the UI application 206 with the ability to control UPnP signaling that occurs between the file system client 204 and the file system server 202. The remote UI control point 218 is a UPnP logical device, thus it can communicate with the remote UT server 208 and remote UI client 212 as indicated by paths 220 and 222, respectively.

The components 202, 204, and 206 may be configured to work in concert to automatically mount network file systems on the file system client 204. These network file systems are provided by the file system server 202. Once discovered and mounted, the network file system is usable by the applications running on the file system client 204 and/or associated hardware. Applications running on the client host machine may access the mounted file system via the appropriate file system API.

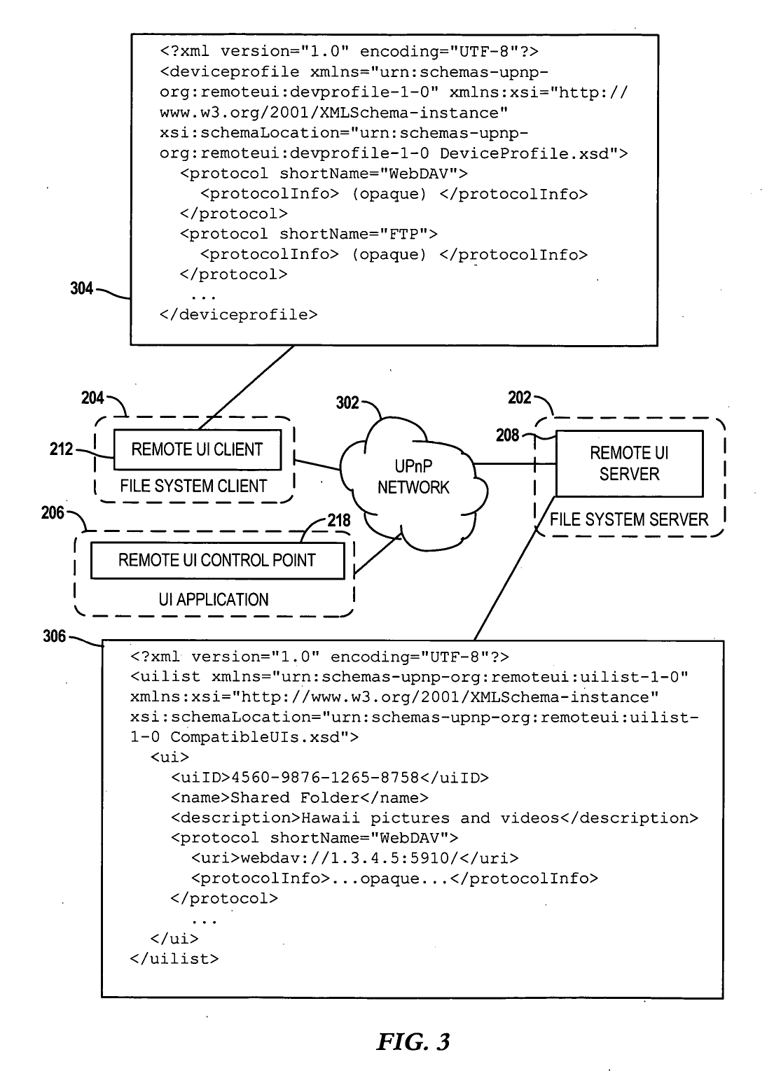

FIG. 3 illustrates data interactions between UPnP network entities that provide automatic mounting of network file systems according to embodiments of the present invention. The illustrated interactions may be used to configuring the remote UI client 212 of a network file system client 204. In order to make the remote UI client 212 visible on a UPnP network 302, the remote UI client 212 publishes information on the network about the device (e.g., the client 204), the device's services, and nested devices. The remote UI client 212 also responds to device queries from the network. In FIG. 3, this device information is presented via a device profile 304. The device profile 304 includes a UPnP state variable used by the remote UI client service 212. The UPnP state variable includes XML-formatted strings used by the client device to represent the list of all supported remoting protocols. In this example the remote UI client 212 indicates that it supports WebDAV and FTP as protocols for remote file systems.

By publishing the device profile 304 on the UPnP network, a UPnP entity such as the control point 218 is able to find a match between a file system client 204 and a file system server 202. The remote UI control point 218 initiates the procedure by sending a GetDeviceProfile( ) action to the remote UI client 212 embedded in the file system client 204. The remote UI client 212 will respond providing the device profile 304.

After retrieving the device profile 304 of the client device 204, the remote UI control point 218 queries one or more remote UI servers 208 for compatible UIs by sending GetCompatibleUIs( ) action. The remote UI server(s) 208 embedded in the file system server(s) 202 will analyze the device profile 304 and will create a response in the form of UI listing 306. In the illustrated example, the server 208 has indicated in the UI listing 306 that it supports WebDAV. After receiving the UI listing 306, the UI application 206 can determine a remote file system protocol (e.g., WebDAV) that is supported by both the file system client 204 and the file system server 202. The UI application 206 can then direct the file system client 204 to mount the network file system by using the compatible protocol.

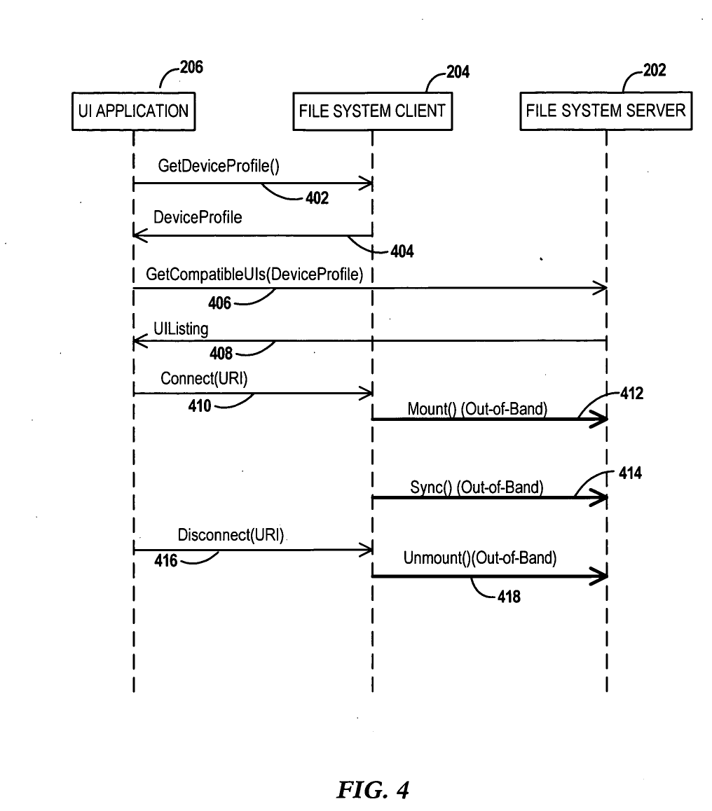

An example procedure for automatically mounting network file systems according to embodiments of the present invention is shown in FIG. 4. As in FIGS. 2 and 3, the transactions involve at least one each of a UI application 206, a file system client 204 and a file system server 202. It will be appreciated the exchanges as illustrated in FIG. 4 may be invoked between any number and combination of UI applications 206, file system clients 204, and file system servers 202. Additionally, the UI applications 206, file system clients 204, and file system servers 202 may reside on any combination of hardware, although typically at least the file system clients 204 and file system servers 202 are located on separate devices.

In the illustrated scenario, the mounting of a remote file system may be initiated by the UI application 206 (e.g., control point), which requests 402 a device profile from the file system client 204. The file system client 204 returns the device profile 404, which generally lists network file system protocols compatible with the file system client 204. The device profile obtained in step 404 is used to request compatible protocols 406 from the file system server 202. The file system server 202 returns a listing 408 of compatible protocols (e.g., a UI listing). If the UIListing 408 returned from the file system server 202 is not empty, the UI application 206 has a client-server match

After the UI application 206 has determined a client-server match, the UP application 206 issues a connect command 410 to the file system client 204 using the Uniform Resource Identifier (URI) of the file system server 202. Based on the connect command 410, the file system client 204 performs an out-of band mounting 412 of a network file system offered by the server 202. The term “out-of-band” refers to data transfers using a protocol layer that is not specifically defined by UPnP (or any XML-based, peer-to-peer protocol of the network). The particular out-of-band protocol used by the client 204 to mount 412 the network file system is defined in the URI passed to the client 204 in the connect command 410.

The connect command 410 may also initiate other interactions not shown in FIG. 4. For example, before mounting 412 the network file system, the UI application 206 or file system client 204 may access a security module for determining passwords, encryption keys, and other access control data used between the file system client 204 and file system server 202. This access control data helps prevent unauthorized access, and may be used to keep the data private after the file system has been mounted 412.

After mounting 412 the file system, the file system client 204 may perform standard file system tasks, including synching 414 data between the client 204 and the server 202. In many network file system, more than one client may access the underlying file hierarchy stored on the file system server 202. Therefore, file system meta-data such as access times, directory contents, etc., may be changed without the file system client 204 being aware of the change. Most network file systems provide means for synchronizing 414 this meta-data, such as by posting events to the client 204, polling, or other methods. Some file systems also have mechanisms that allow synchronizing the content of files that reside both on the client 204 and the server 202.

Generally, the client 204 may have locally stored files that are mirrored on the server 202. The client files may have a different version than the server files. Therefore, these two versions can be synchronized by replacing or updating the older version with the newer version. One example of a network file system that deals with synchronizing of remote data is WebDAV. In the illustrated example, the file system client 204 may contain a Web log (e.g., a “blog”) that is maintained by the author on a mobile device. Once in the home environment, the author may want the contents of the log to be automatically updated on the file system server 202. Therefore, after the file system client has mounted 412 the network file system, the synchronization 414 may involve updating the contents of the blog on the file system server 202 using WebDAV.

When the UI application 206 and/or file system client 204 disconnects from the network, the mounted network file system must be unmounted. This is achieved by issuing a disconnect command 416 to the file system client 204, which then unmounts 418 the network file system using out-of-band protocols. This unmounting 418 of the network file system may occur as a result of network disconnection, or may be initiated by the user or device software. For example, a device that goes into standby may unmount 418 before going into the reduced power mode.

There may be cases where some communications between the UI application 206 and the file system client 264 or between the UI application 206 and the file system server 202 is performed out of band. For example, these communications may be performed using Short Message Service (SMS) configuration message. In these scenarios, the UI application 206 may still use UPnP to configure the file system client 204, file system server 202 or any other UPnP entity depending on the context of the configuration message.

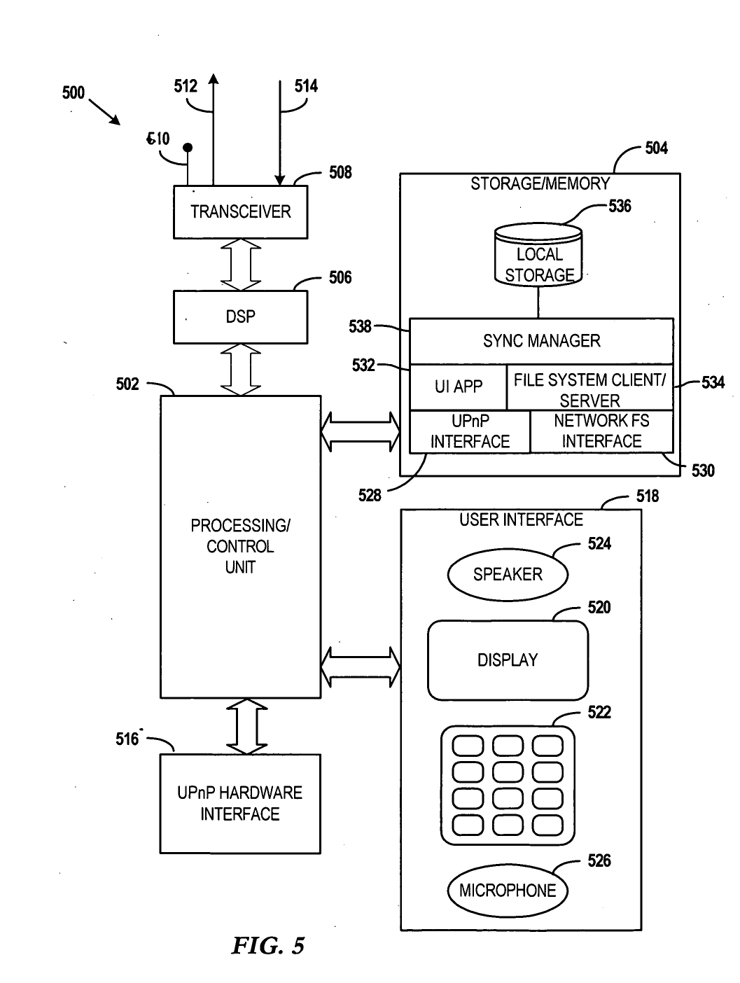

The UPnP standard is flexible enough to allow many types of apparatus to perform roles as file system servers, file system clients, and UI control points. Mobile devices are particularly useful as control points, and may also be used as file system clients and servers. In reference now to FIG. 5, an example mobile computing arrangement 500 is illustrated that is capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The illustrated mobile computing arrangement 500 may suitable at least for performing roles as both a file system client and a control point in a UPnP network. The mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EtPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The program storage/memory 504 may also include operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes wireless data transmission circuitry for performing network data exchanges.

This wireless circuitry includes a digital signal processor (DSP) 506 employed to perform a variety of functions, including analog-to-digital (AMD) conversion, digital-to-analog (D/A) conversion, speech coding/decoding, encryption/decryption, error detection and correction, bit stream translation, filtering, etc. A transceiver 508, generally coupled to an antenna 510, transmits the outgoing radio signals 512 and receives the incoming radio signals 514 associated with the wireless device.

The mobile computing arrangement 500 may also include a UPnP hardware interface 516 coupled to the processing/control unit 502. The UPnP hardware interface 516 may include the ability to communicate on a UPnP network using any manner of data transmission medium, including wired and wireless mediums. The processor 502 is also coupled to user-interface 518 elements associated with the mobile terminal. The user-interface 518 of the mobile terminal may include, for example, a display 520 such as a liquid crystal display, a keypad 522, speaker 524, and microphone 526. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The storage/memory 504 of the mobile computing arrangement 500 may include software modules for communicating over a UPnP network. In particular, a UPnP data interface 528 provides the abilities to deal with various protocol layers defined in one or more UPnP standards. The storage/memory 504 also includes a network file system interface 530 that provides out-of-band network file system services. The services provided by the file system interface 530 may include both client and server functionality. The UPnP data interface 528 and network files systems interface 530 may be configured to operate via one or both of the transceiver 508 and UPnP hardware interface 516.

The storage/memory 504 may also include a UPnP UI application 532. The UI application 532 may interact with the user interface hardware 518 of the device to allow a user to control elements of a UPnP network. For example, the UI application 532 may allow using the display 520 and keypad 522 to remotely control UPnP devices. The UI application 532 may also interact with a file system client/server module 534 for remotely mounting network file systems. The file system client/server module 534 provides manual and automatic controls for mounting and umnounting remote file systems. The file system client/server module 534 may also act as a server, providing access to files of a local storage element 536 via the network file system interface 530.

The file system client/server module 534 may communicate with both the UPnP interface 528 and the out-of-band network file system interface 530. In particular, when acting as file system client, the module 534 may accept connect requests via UPnP, and service those requests (e.g., mount a network file system) using out-of-band protocols. The file system client/server module 534 may also handle various out-of-band file transactions, including transferring files, updating file system metadata, and providing file system status and data to other elements, such as the UI application 532. Out-of-band transactions handled by the file system client/server module 534 may include synchronizing file data. This synchronization may include within the module 534 itself, or via an external synchronization manager component 538. For example, the file system client/server module 534 and network file system interface 530 may be enabled to utilize HTTP to transfer files and file data to and from the device. The synchronization manager component 538 may utilize WebDAV extensions to HTTP that enable synchronizing file data with other WebDAV enabled clients/servers.

The mobile computing arrangement 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of mounting network file systems to a client arrangement via an ad hoc, peer-to-peer, local area network, comprising:
coupling the client arrangement to the network;
determining one or more network file protocols that are compatible with the client arrangement;
sending, using XML-based discovery protocols of the network, descriptors of the one or more network file protocols to a file server coupled to the network;
receiving from the file server a descriptor of at least one network file protocol compatible with the file server, the compatible file protocol selected from the one or more network protocols; and
mounting a network file system provided by the file server to the client arrangement using the compatible network file protocol.

2. The method of claim 1, further comprising:
receiving a signal to disconnect the client arrangement from the ad-hoc peer to peer, local area network; and
unmounting the network file system using the compatible network file protocol in response to the signal.

3. The method of claim 1, further comprising:
after mounting the network file system, synchronizing the content of data files that have a first version located on the client arrangement and a second version located on the file server, wherein the first version differs from the second version.

4. The method of claim 1, wherein determining the one or more network file protocols comprises querying the client arrangement using the XML-based discovery protocols to determine the one or more network file protocols that are compatible with the client arrangement.

5. The method of claim 1, wherein mounting the network file system to the client arrangement using the compatible network file protocol comprises mounting the network file system using any combination of file transfer protocol (FTP), WebDAV, and server message block (SMB).

6. The method of claim 1, wherein the ad-hoc, peer-to-peer network comprises a Universal Plug and Play (UPnP) network.

7. The method of claim 6, wherein sending the descriptors of the network file protocols using XML-based discovery protocols of the network comprises sending a UPnP device profile.

8. The method of claim 6, wherein receiving from the file server a descriptor of at least one network file protocol compatible with the file server comprises receiving a UPnP UIListing from the file server.

9. The method of claim 6, wherein determining the one or more network file protocols comprises querying the client arrangement via a UPnP remote UI control point to determine the one or more network file protocols that are compatible with the client arrangement.

10. The method of claim 6, wherein mounting the file system to the client arrangement comprises connecting to the system via a UPnP remote UI client associated with the client arrangement.

11. The method of claim 1, wherein coupling the client arrangement to the network comprises wirelessly coupling the mobile device to the network.

12. A data-processing arrangement, comprising:
a network interface capable of being coupled to an ad hoc, peer-to-peer, local area network;
a processor coupled to the network interface; and
a memory coupled to the processor, the memory containing instructions that cause the processor to,
determine one or more network file protocols that are compatible with the data processing arrangement;
send, using XML-based discovery protocols of the network, descriptors of the one or more network file protocols to a file server coupled to the network;
receive from the file server a descriptor of at least one network file protocol compatible with the file server, the compatible file protocol selected from the one or more network protocols; and
mount a network file system provided by the file server using the compatible network file protocol.

13. The data-processing arrangement of claim 12, wherein the instructions further cause the processor to:
receive a signal to disconnect the data-processing arrangement from the network; and
unmount the network file system using the compatible network file protocol in response to the signal.

14. The data-processing arrangement of claim 12, wherein the instructions further cause the processor to, after mounting the network file system, synchronize the content of data files that have a first version located on the data-processing arrangement and a second version located on the file server, wherein the first version differs from the second version.

15. The data-processing arrangement of claim 12, wherein the network file system comprises any combination of file transfer protocol (FTP), WebDAV, and server message block (SMB).

16. The data-processing arrangement of claim 12, wherein the ad-hoc, peer-to-peer network comprises a Universal Plug and Play (UPnP) network.

17. The data-processing arrangement of claim 16, wherein the descriptors of one or more the network file protocols comprise a UPnP device profile.

18. The data-processing arrangement of claim 16, wherein the descriptor of a network file protocol compatible with the file server comprises a UPnP UIListing.

19. The data-processing arrangement of claim 12, wherein the network interface comprises a wireless network interface.

20. A processor-readable medium having instructions stored thereon which are executable by a data processing arrangement capable of being coupled to an ad-hoc, peer-to-peer, local area network, the instructions executable by the data processing arrangement for performing steps comprising:
determining one or more network file protocols that are compatible with the data processing arrangement;
sending, using XML-based discovery protocols of the network, descriptors of the one or more network file protocols to a file server coupled to the network;
receiving from the file server a descriptor of at least one network file protocol compatible with the file server, the compatible file protocol selected from the one or more network protocols; and
mounting a network file system provided by the file server using the compatible network file protocol.

21. The processor-readable medium of claim 20, wherein the steps further comprise:
receiving a signal to disconnect the data-processing arrangement from the network; and
unmounting the network file system using the compatible network file protocol in response to the signal.

22. The processor-readable medium of claim 20, wherein the instructions further cause the processor to, after mounting the network file system, synchronize the content of data files that have a first version located on the data processing arrangement and a second version located on the file server, the first version differing from the second version.

23. A data-processing arrangement, comprising:
a network interface capable of being coupled to an ad hoc, peer-to-peer local area network;
a processor coupled to the network interface;
a data store having a local file system; and
a memory coupled to the processor and the data store, the memory having instructions that cause the processor to,
receive, using XML-based discovery protocols of the network, descriptors of one or more network file protocols that are compatible with a client arrangement coupled to the network;
select from the one or more network file protocols at least one network file protocol that is compatible with the data processing arrangement;
send to the client arrangement a descriptor of the at least one network file protocol; and
enable mounting of a portion of the local file system by the client arrangement using the compatible network file protocol.

24. The data-processing arrangement of claim 23, the network file system comprises any combination of file transfer protocol (FTP), WebDAV, and server message block (SMB).

25. The data-processing arrangement of claim 23, wherein the ad-hoc, peer-to-peer network comprises a Universal Plug and Play (UPnP) network.

26. The data-processing arrangement of claim 25, wherein the descriptors of one or more the network file protocols comprise a UPnP device profile.

27. The data-processing arrangement of claim 25, wherein the descriptor of a network file protocol compatible with the file server comprises a UPnP UIListing.

28. The data-processing arrangement of claim 23, wherein the network interface comprises a wireless network interface.

29. A processor-readable medium having instructions stored thereon which are executable by a data processing arrangement capable of being coupled to an ad-hoc, peer-to-peer local area network, the instructions executable by the data processing arrangement for performing steps comprising:
receiving, using XML-based discovery protocols of the network, descriptors of one or more network file protocols that are compatible with a client arrangement coupled to the network;
selecting from the one or more network file protocols at least one network file protocol that is compatible with the data processing arrangement;
sending to the client arrangement a descriptor of the at least one network file protocol; and
enabling mounting of a portion of a local file system of the data processing arrangement by the client arrangement using the compatible network file protocol.

30. A system comprising:
a local, ad hoc, peer-to-peer network;
means for coupling a client arrangement to the network;
means for determining one or more network file protocols that are compatible with the client arrangement;
means for sending, using XML-based discovery protocols of the network, descriptors of the one or more network file protocols to a file server coupled to the network;
means for receiving from the file server a descriptor of at least one network file protocol compatible with the file server, the compatible file protocol selected from the one or more network protocols; and
means for mounting a network file system provided by the file server to the client arrangement using the compatible network file protocol.
